(19) United States
(12) Patent Application Publication
(10) Pub. No.: US 2016/0342508 A1
(43) Pub. Date: Nov. 24, 2016

(54) IDENTIFYING MEMORY REGIONS THAT CONTAIN REMAPPED MEMORY LOCATIONS

(71) Applicant: HEWLETT PACKARD ENTERPRISE DEVELOPMENT LP, Houston, TX (US)

(72) Inventors: Gregg B LESARTRE, Fort Collins, CO (US); Matthew B. LOVELL, Longmont, CO (US); Naveen MURALIMANOHAR, Santa Clara, CA (US)

(21) Appl. No.: 15/114,459

(22) PCT Filed: Jan. 31, 2014
(86) PCT No.: PCT/US2014/014041

§ 371 Date: Jul. 27, 2016

(51) Int. Cl. G06F 12/02; G06F 11/10

(52) U.S. Cl. CPC G06F 12/023; G06F 11/1004; G06F 2212/1032

(57) ABSTRACT

A method for identifying memory regions that contain remapped memory locations is described. The method includes determining, from a number of tracking bits on a memory module controller, whether a memory region comprises a remapped memory location. The method further includes performing a remapped memory operation on the memory region based on the determination, wherein memory within a computing device is divided into a number of memory regions including the memory region.

### BACKGROUND

Memory is used to store data. Businesses, organizations, or other users use the data for any variety of purposes. For example, a business organization may use memory to store large amounts of data. The operations of a business, organization, or other user may rely heavily on the performance of memory. Memory controllers may be used to manage the storage of data to memory and access to the data stored on the memory.

### BRIEF DESCRIPTION OF THE DRAWINGS

The accompanying drawings illustrate various examples of the principles described herein and are a part of the specification. The illustrated examples do not limit the scope of the claims.

FIG. 1 is a diagram of a system for identifying memory regions that contain remapped memory locations according to one example of the principles described herein.

FIG. 2 is a flowchart of a method for identifying memory regions that contain remapped memory locations according to one example of the principles described herein.

FIG. 3 is a flowchart of a method for performing a write operation on a memory region that contains a remapped memory location according to one example of the principles described herein.

FIG. 4 is a diagram of a remapping procedure according to another example of the principles described herein.

FIG. 5 is a diagram of a flat data structure according to one example of the principles described herein.

FIG. 6 is a diagram of a multi-dimensional array data structure according to one example of the principles described herein.

FIG. 7 is a diagram of a bloom filter tracking structure according to one example of the principles described herein.

FIG. 8 is a diagram of a memory module controller for identifying memory regions that contain remapped memory locations according to one example of the principles described herein.

Throughout the drawings, identical reference numbers designate similar, but not necessarily identical, elements.

### DETAILED DESCRIPTION

As described above, memory may be used to store data. For example, businesses and other organizations may process large amounts of data and may use memory systems to store the data. With the exponential growth in data use, memory systems have been designed to handle the growing demands. However, while memory systems may be increasing in capabilities, many characteristics may lead to inefficient data storage.

For example, memory may be divided up into a number of memory locations. The memory locations may be of any particular size. A memory location may include a number of memory bits that represent stored data. As a memory location fails, the memory location may be designated as “bad” and this location may be set aside and is no longer used to store data. The data that is intended to be stored in that memory location may then be remapped to another memory location. Still, while such remapping may alleviate some of the complications associated with memory bit failure, other characteristics render remapping inefficient.

For example, while a “bad” memory location may contain a number of failed memory bits, the memory location may yet contain a number of available memory bits that have not failed. By disregarding an entire “bad” memory location, those available non-failing memory bits are no longer available to store data. Accordingly, the effective storage capacity of memory is reduced, not just by the number of failed bits, but by the size of the memory location that contains the failed bit.

Similarly, following a remapping in general may be time intensive and may use additional bandwidth as before data is written to a memory location, it is read to ensure that the memory location does not include an active remapping. Writing to a memory location without first reading to determine whether data has been remapped may overwrite the remapping and the corresponding remapped data may be lost.

Accordingly, the present disclosure describes systems and methods for identifying memory regions that include remapped memory locations. In other words, memory divisions that include a data remapping may be identified at a coarser granularity.

The systems and methods described herein describe a remapping procedure that may recognize when a memory location has had some memory bits fail and as such is a “bad” memory location. The remapping procedure may also provide an alternate location for the data. A pointer to the new data may be included in the memory location such that the “bad” memory location remains usable. For example, the remapping procedure may utilize memory locations that include failed bits to store a pointer that indicates where the data has been remapped to. In other words, although a memory location may include a number of failed bits, the remapping procedure may utilize space within the bad memory location to include a pointer that indicates the data remapping. Such a remapping procedure may be a fine-grained remapping with error correcting code and embedded pointers (FREE-p) mapping.

As described above, the remapping procedure may be time consuming and computationally expensive. Accordingly, the systems and methods described herein also provide for a memory module controller that implements a tracking system to identify, at a coarser granularity, whether a memory region includes memory locations that have been remapped using a remapping procedure such as FREE-p. If a memory region includes remapped memory locations, then the remapping function may be followed within that memory region. By comparison, if a memory region does not include remapped memory locations, data may be written to the memory region without executing the remapping function.

The present disclosure describes a method for identifying memory regions that contain remapped memory locations. The method may include determining, from a number of tracking bits on a memory module controller, whether a memory region comprises a remapped memory location. The method may further include performing a remapped memory operation on the memory region based on the determination, wherein memory within a computing device is divided into a number of memory regions including the memory region.

The present disclosure describes a system for identifying memory regions that contain remapped memory locations. The system may include a processor and memory communicatively coupled to the processor. The system may also include a memory module controller. The memory module controller may include a divide module to divide memory into a number of memory regions. A memory region may include a number of memory locations. The memory module controller may also include a track module to identify memory regions that include a remapped memory location based on a number of tracking bits located in the memory module controller. The memory module controller may further include an operation module to perform a remapped write operation to a memory region identified as containing the remapped memory location.

The present disclosure describes a computer program product for identifying memory regions that contain remapped memory locations. The computer program product may include a computer readable storage medium. The computer readable storage medium may include computer usable program code embodied therewith. The computer usable program code may include computer usable program code to, when executed by a processor, divide memory within a computing device into a number of memory regions. The computer usable program code may include computer usable program code to, when executed by a processor, identify a number of remapped memory locations within a memory region based on a number of tracking bits within a memory module controller. The computer usable program code may include computer usable program code to, when executed by a processor, perform a remapped memory operation to the number of remapped memory locations, in which the remapped memory operation is based on a remapping function.

The systems and methods described herein may be beneficial in that it may allow the use of remapping to memory locations that provides robust memory in the face of failing memory bits and may reduce the performance overhead of a remapping procedure when processing writes to memory.

As used in the present specification and in the appended claims, the term “memory bit” may refer to a computing element that stores information. Further, a “failed” memory bit may refer to a memory bit that is no longer able to store data. For example, the memory bit may be worn-out indicating a threshold number of writes to that bit has been reached.

Further, as used in the present specification and in the appended claims, the term “memory region” may refer to a division of the memory. For example, memory may be divided into a number of memory regions. A memory region may include a number of memory locations. Accordingly, a “memory location” may be a finer division of memory than a memory region. A “bad” memory location may be a memory location that contains any number of “failed memory bits.” In this example, a “bad memory location” may include both failed memory bits and available memory bits.

Still further, as used in the present specification and in the appended claims, the term “remapping function” may include any remapping procedure that indicates data intended to be stored in one memory location has been moved to a different location. An example of a remapping function is a fine-grained remapping with error correcting code and embedded pointers (FREE-p).

Even further, as used in the present specification and in the appended claims, the term “a number of” or similar language may include any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

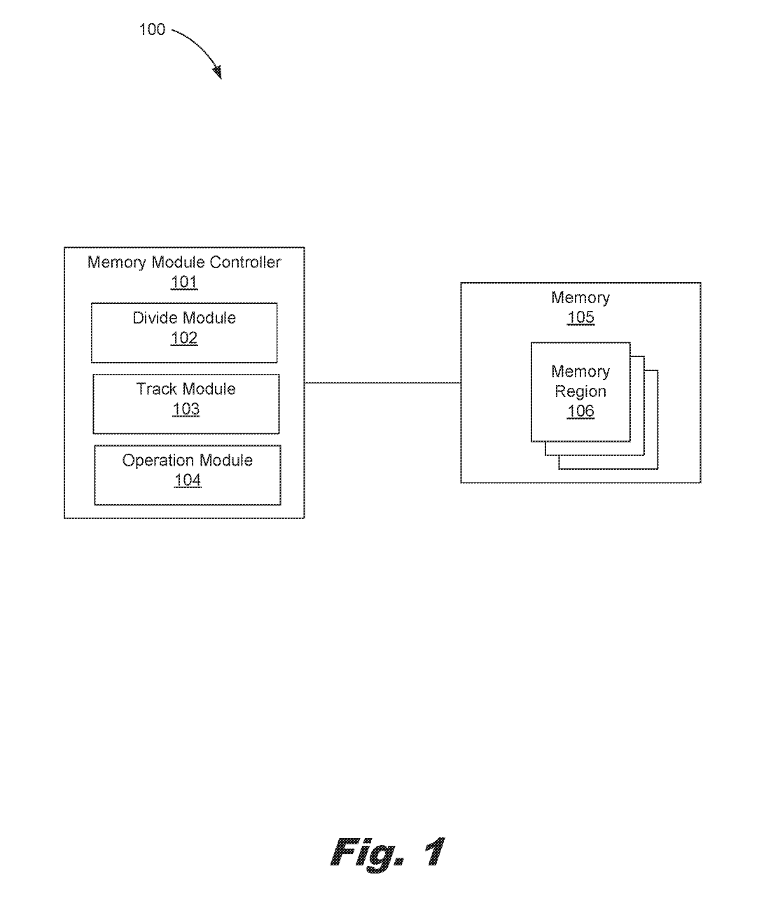

Turning now to the figures, FIG. 1 is a diagram of a system (100) for identifying memory regions (106) that contain remapped memory locations according to one example of the principles described herein. The system (100) may include memory (105). As described above, memory (105) may include any element for storing data. For example, memory (105) may include a number of bits that store information.

The memory (105) may include a number of memory regions (106). A memory region (106) may refer to a division of the bits within memory (105) that are used to store data. Each memory region (106) may include a number of memory locations. Each memory location may include a number of bits.

For example, a first memory region (106) may include a number of memory locations, and a second memory region (106) may include a number of memory locations. A number of address bits may be used to uniquely identify each memory region (106). For example, 10 address bits may be used to identify a number of memory regions (106). The number of memory regions (106) that may be identified by a number of address bits may be determined by the dividing procedure used, as will be described below in greater detail. For example, a flat data structure and a multi-dimensional data array structure may be used to divide the memory (105) into a number of memory regions (106).

As described above, a memory location may include a number of memory bits that store data. In some examples, a memory bit within a memory location may fail for any number of reasons including wear-out failures, electrical shorts, among other types of bit failures. In this example, a failed memory bit may not be able to store information. Accordingly, a memory module controller (101) may remap the data intended to be stored in the memory location with a failed memory bit to another memory location. In this example, a memory location that contains any number of failed memory bits may be referred to as a “bad” memory location. A bad memory location may include a number of bits that have not failed. Accordingly, a bad memory location may include a number of available memory bits and a number of failed memory bits.

The system (100) may include a memory module controller (101) to manage the access and storage of data on the memory (105). In particular the memory module controller (101) may include a number of elements to manage the storage of data, and access to the data, in the memory (105). For example, the memory module controller (101) may include a divide module (102) to divide the memory (105) into a number of memory regions (106). A number of different procedures may be used to divide memory (105) into a number of memory regions (106). Using a “flat” data structure, a number of address bits may be decoded into a number of regions. For example, 10 address bits may be used to divide the memory (105) into approximately 1,024 different memory regions (106). As will be described below, in this example approximately 1,024 tracking bits may be used to identify the memory regions (106). In some examples, the 10 bits may be hashed to improve the patterns of access to the memory regions (106). While specific reference is made to 10 address bits, any number of address bits may be used to identify memory regions (106).

Using a multi-dimensional data array, a number of address bits may be divided into different groups. Doing so may reduce the number of tracking bits used to identify memory regions (106) that contain remapped memory locations. For example, 10 address bits may be split into two groups of 5 address bits. Each group of 5 address bits may be used to define approximately 32 memory regions (106). By crossing the two groups of 5 address bits, the number of uniquely identifiable memory regions (106) may be approximately 1,024. However, in this example approximately 64 (resulting from the addition of the two groups of 32 memory regions (106) identified by the 5 address bits) tracking bits may be used to identify the memory regions (106). Accordingly, a multi-dimensional array may reduce the number of tracking bits used to map a determined number of memory regions (106).

While specific reference is given to particular data dividing procedures, any type of procedure that divides memory (105) into a number of memory regions (106) may be implemented in accordance with the principles described herein. Dividing the memory (105) into memory regions (106) may be beneficial in that it may allow for easier access to the data as the memory regions (105) may provide a finer granularity data access, which may reduce access latency. For example, it may be quicker to track multiple small memory regions (106) rather than tracking one large memory (105).

The memory module controller (101) may also include a track module (103) to track whether a memory region (106) contains a remapped memory location. For example, a first memory region (106) may include a memory location that includes a failed bit, and may accordingly map the data to be stored in that location, to a second memory region (106). In some examples, the track module (103) may be included on the memory module controller (101). The number of tracking bits used to identify a memory region (106) that contains a remapped memory location may be based on the dividing procedure used. For example, as described above, in a flat data structure with 10 address bits defining 1,024 mapping regions (106), 1,024 tracking bits may be used. By comparison in a multi-dimensional data array structure with two groups of 5 bits defining 1,024 mapping regions (106), 64 tracking bits may be used.

As will be described below, in some examples, the remapping procedure may also utilize a finer-grain remapping flag to indicate whether a memory location has been remapped. However, the tracking bit on the track module (103) may be a courser granularity. For example, the tracking bit on the track module (103) may identify memory regions (106) that include remapped locations while a finer-grain remapping flag used by a remapping procedure may identify the specific locations that include remapped data. Moreover, as the tracking bit may be stored on the memory module controller (101) it may be more quickly determined whether a particular memory region (106) contains a remapped location as it does not have to access a different memory locations.

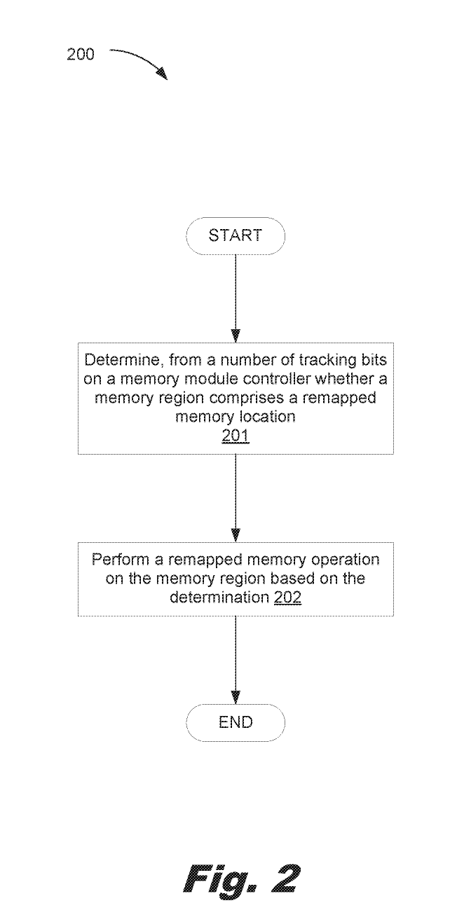

The memory module controller (101) may include an operation module (104) to perform a remapped memory operation to the memory region (106) identified as containing a remapped memory location. For example, the operation module (104) may perform a write operation to a memory location if the memory location has not been remapped. By comparison, the operation module (104) may perform a remapped write operation to a memory region identified as containing a remapped memory location. The remapped write operation may include performing a preliminary read operation to determine the new location where the data should be written. The location of the remapped data may be identified by a pointer located in the original memory location. The operation module (104) may then write the data to the new location. For example, if the track module (103) indicates that a particular memory region (106) does include a remapped memory location, the operation module (104) may write data to the memory region (106) based on a remapped memory operation. More detail regarding various remapped memory operations is given below in connection with FIG. 2. By comparison, if the track module (103) indicates that a particular memory region (106) does not include a remapped memory location, the write module (104) may write data to the memory region (106), disregarding any remapping operation.

Writing data to memory (105) based on a track module's indication of remapped memory locations may be beneficial in that the remapped memory operation may be used when indicated, and a quicker writing procedure may be implemented when a memory region (106) does not include a remapped memory location. In other words, a remapping procedure such as FREE-p may be implemented without consuming large amounts of extra bandwidth when data is to be written to a remapped memory location. Memory (105) access latency may also be improved. In some examples, the memory module controller (101) may be communicatively coupled to a memory controller that may manage other aspects of the memory (105). In some examples, the memory module controller (101) may be coupled to an input/output device, or an input/output controller. In some examples, the memory module controller (101) may be located within a volatile memory of the computing device.

FIG. 2 is a flowchart of a method (200) for identifying memory regions (FIG. 1, 106) that contain remapped memory locations according to one example of the principles described herein. The method (200) may include determining (block 201) from a number of tracking bits on a memory module controller (FIG. 1, 101) whether a memory region (FIG. 1, 106) comprises a remapped memory location. For example, when a remapping operation, such as a FREE-p mapping operation remaps a memory location, the memory module controller (FIG. 1, 101) may set a tracking bit, or a number of tracking bits, to indicate the memory region contains a memory location that has been remapped. In this example, a value of the number of tracking bit may indicate whether a particular memory region (FIG. 1, 106) corresponding to the tracking bit includes a remapped memory location. As used herein, a remapped memory location may indicate that a particular memory location includes a remapping of data intended for that memory location to another memory location. For example, a memory location may include a number of failed bits, and may remap the data represented by that memory location to another memory region (FIG. 1, 106).

In some examples, remapped data may be remapped using a FREE-p mapping. A FREE-p mapping may implement a pointer in a particular memory location, which memory location may include a number of failed bits. The pointer may indicate a different memory location where the data corresponding to the failed memory bit has been moved. Using a FREE-p mapping in this example may be beneficial as it uses a fine grain remapping to map out small divisions that indicate failed bits. This may be beneficial as a finer granularity of memory locations may result in more memory being available for use. Moreover, FREE-p mapping may be beneficial in that it uses memory space within the bad memory location to include the pointer. In other words, while the memory location may include a number of failed bits, bits that have not failed that are within the bad memory location may include a pointer to the remapped data as well as a flag that indicates a FREE-p mapping.

The method (200) may include performing (block 202) a remapped memory operation on the memory (FIG. 1, 105) based on the determination as to whether a memory region (FIG. 1, 106) comprises a remapped memory location.

In some examples, a remapped memory operation may include a number of operations. For example, a remapped memory operation may include a remapped write operation. A remapped write operation may include a read operation and a write operation. As a specific example, during a FREE-p operation, a memory location is read to determine whether there is remapped data in the memory location and if there is, the pointer directs the memory module controller (FIG. 1, 101) to the location of the remapped data, to which the data may be written.

Accordingly, in a remapped write operation, the memory location may first be read to determine whether remapped data is located within the memory location. After the initial read, a write operation may be executed either to the original memory location or to the memory location to which the data was remapped to. Accordingly, a remapped write operation may include an initial read that may increase latency in terms of how long it takes to complete a write operation.

Returning to the method (200), the memory module controller (FIG. 1, 101) may perform read operations and write operations on a memory region (FIG. 1, 106) according to the FREE-p mapping procedure if the track module (FIG. 1, 103) indicates that a memory region (FIG. 1, 106) contains a remapped memory location. By comparison, if the track module (FIG. 1, 103) indicates that a memory region (FIG. 1, 106) does not contain any remapped memory locations, the memory module controller (FIG. 1, 101) may execute read operations and write operations disregarding any remapped memory operations. Performing (block 203) a remapped memory operation based on the determination as to whether a memory region (FIG. 1, 106) contains a remapped memory location may be beneficial as a potentially more time extensive remapped operations may be performed as needed, and in cases when it is not needed, shorter write operations may be executed.

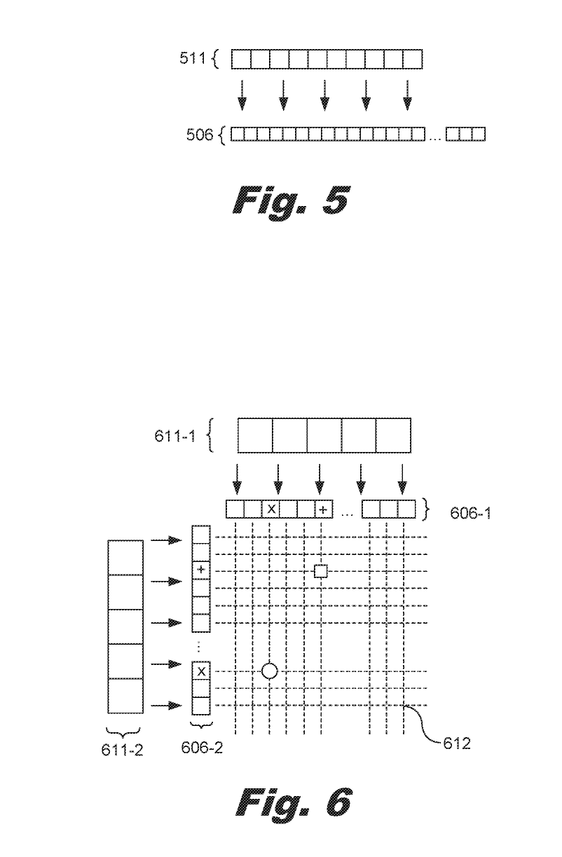

The memory may be divided into a number of memory regions (FIG. 1, 106). As described above, memory (FIG. 1, 105) may be divided into a number of smaller memory regions (FIG. 1, 106) to improve memory access latency. The memory (FIG. 1, 105) may be divided using any number of dividing procedures. For example, memory (FIG. 1, 105) may be divided into a flat structure. In other words a single array of address bits may be used to divide the memory (FIG. 1, 105) into a number of memory regions (FIG. 106). As a specific example, 10 address bits may be used to divide the memory (FIG. 1, 105) into 1,024 memory regions (FIG. 1, 106). In some examples, a hash function, or other logic, may be employed to improve memory access latency. More detail concerning a flat data structure is given below in connection with FIG. 5.

In another example, the memory (FIG. 1, 105) may be divided into a multi-dimensional data array. In a multi-dimensional data array, a number of address bits may be grouped into a number of dimensions. For example, 10 address bits may be grouped into two groups of 5 bits. While specific reference is made to 2 groups or dimensions, any number of dimensions or groups of bits may be implemented as described herein. In this example, a first group of 5 bits may divide the memory (FIG. 1, 105) into 32 different memory regions (FIG. 1, 106) and a second group of 5 bits may divide the same memory (FIG. 1, 105) into 32 different memory regions (FIG. 1, 106). Crossing the two dimensions, 1,024 memory regions (FIG. 1, 106) may be uniquely identified. More detail concerning a multi-dimensional data array is given below in connection with FIG. 6. Dividing the memory (FIG. 1, 105) using a multi-dimensional data array may be beneficial in that it allows more distinct memory regions (FIG. 1, 106) to be tracked by fewer tracking bits.

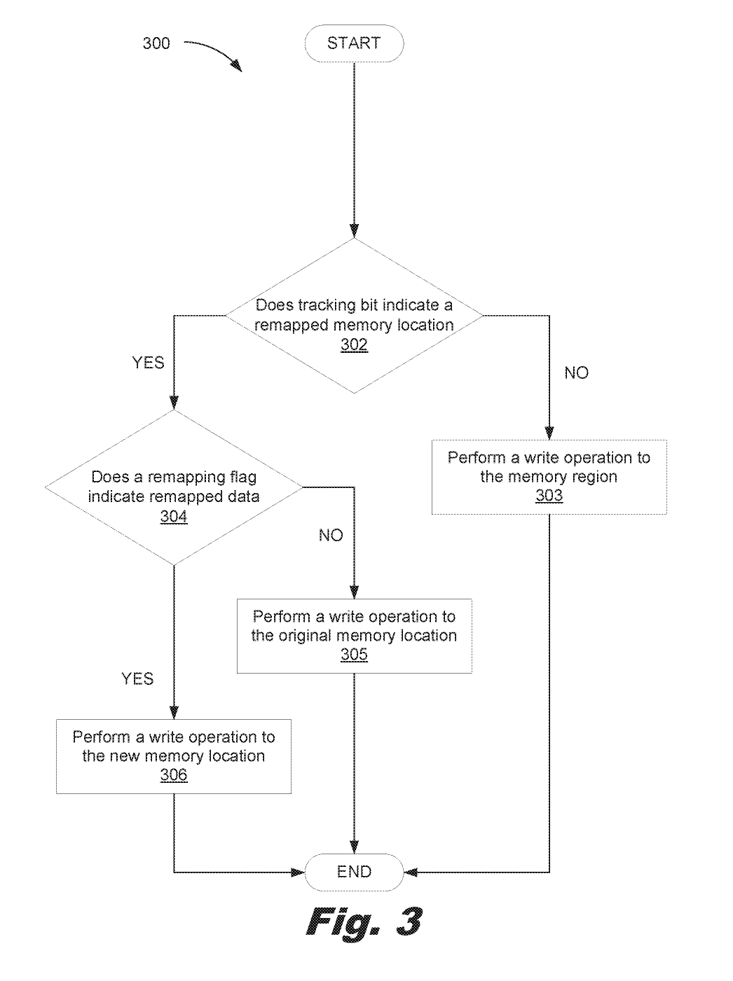

FIG. 3 is a flowchart of a method (300) for performing a write operation on a memory region (FIG. 1, 106) that contains a remapped memory location according to one example of the principles described herein.

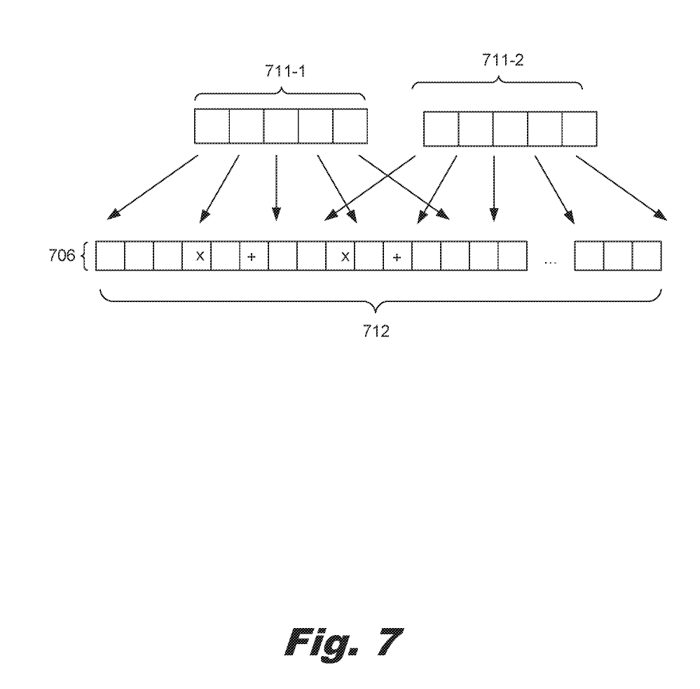

The method (300) may include determining (block 302) from a number of tracking bits on a memory module controller (FIG. 1, 101) whether a memory region (FIG. 1, 106) comprises a remapped memory location. This may be performed as described in connection with FIG. 2. In some examples, the track module (FIG. 1, 103) may implement a bloom filter to indicate whether a memory region (FIG. 1, 106) includes a remapped memory location. More detail regarding a bloom filter is given below in connection with FIG. 7.

If the tracking bit does not indicate that a remapped memory location may be in the accessed memory region (block 302, determination NO), the memory module controller (FIG. 1, 101) may perform (block 303) a write operation to the memory region (FIG. 1, 106). For example, if the tracking bit does not indicate a FREE-p mapping, a write operation may be performed without an initial read of the memory region.

By comparison, if the tracking bit does indicate a remapped memory location may be in the accessed memory region (block 302, determination YES), the memory module controller (FIG. 1, 101) may determine (block 304) whether a remapping flag indicates a memory location's data is remapped. As described above, the remapping flag may use a fine-grain procedure to indicate remapped data. For example, the remapping flag may be implemented on a cache line granularity of approximately 64 bytes. Determining (block 304) whether a remapping flag indicates a memory location contains remapped data may include performing a read operation of the memory locations within the memory region (FIG. 1, 106) to obtain a remapping flag.

If the memory location does not include a remapping flag (block 304, determination NO), the write module (FIG. 1, 104) may then perform (block 305) a write operation on the original memory location. By comparison, if the memory location does include a remapping flag (block 304, determination YES), the write module (FIG. 1, 104) may perform (block 306) a write operation on the new memory location. In other words, the write module (FIG. 1, 104) may be directed to write the data to another memory location as indicated by the remapping flag located in the original memory location. Performing an operation based on the determination as to whether a memory region (FIG. 1, 106) contains a remapped memory location may be beneficial as a potentially more time extensive remapping may be performed as needed, and in cases when it is not needed, an initial read process may be avoided.

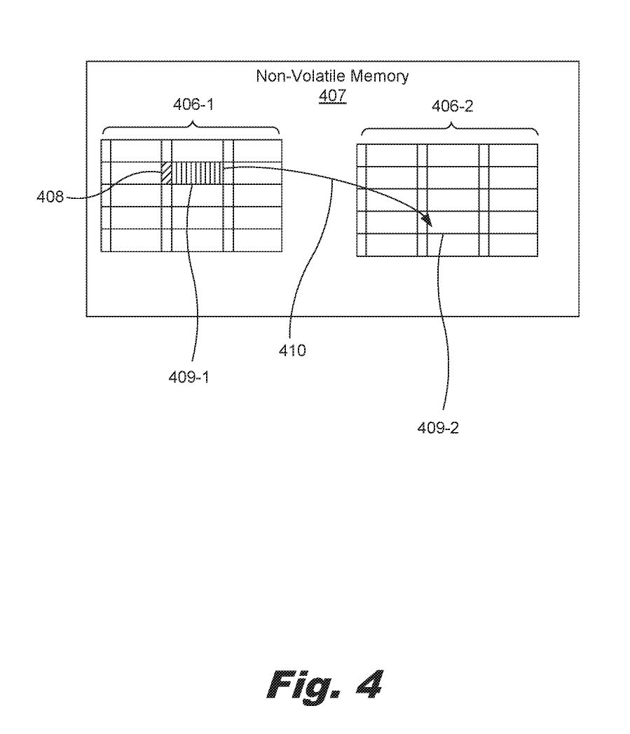

FIG. 4 is a diagram of a remapping procedure according to another example of the principles described herein. In some examples, the system (FIG. 1, 100) may include non-volatile memory (407) that continues to store data once power is removed from the system (FIG. 1, 100). As described above, the non-volatile memory (407) may include a number of memory regions (406-1, 406-2). More specifically, the non-volatile memory (407) may include a first memory region (406-1) that includes a number of memory locations and a second memory region (406-2) that includes a number of memory locations. As described above, in some examples, a memory location may include a number of failed memory bits. For example, the first memory region (406-1) may include a failed memory block (409-1) as indicated by the vertical lines. In this example, a number of bits within the failed memory block (409-1) may be used to remap the data represented in that block to a remapped location (409-2) in a second memory region (406-2). The remapping directed by the pointer may be indicated by the arrow (410). In some examples, the pointer may be much smaller than the data block (409-1) that it is remapping. In some examples, a remapped flag (408) may be used to indicate that a particular memory location (409) includes remapped data.

FIG. 5 is a diagram of a flat data structure according to one example of the principles described herein. As described above, a number of address bits (511) may be used to identify a number of memory regions (506). For example, 10 address bits (511) may be used to uniquely identify approximately 1,024 memory regions (506). Using a flat structure as described herein may be beneficial in that it reduces a propensity for false matches. In other words, using a flat structure may eliminate the likelihood that a memory region (506) will be indicated as having a remapped memory location, when in reality the memory region (506) does not have a remapped memory location. As indicated, with a flat data structure, a tracking bit may be used to track each memory region (506). Accordingly, 1,024 tracking bits may be used to track 1,024 memory regions (506), given 10 address bits in a flat data structure. In some examples, given a flat data structure, a number of logical operations may be applied to improve the performance of the system (FIG. 1, 100). For example, “xor,” “and,” and hash functions, among other logical operations, may be used to allow the 10 address bits (511) to uniquely identify 1,024 memory regions (506). When the address bits (511) indicate a memory region (506) does contain a remapped location, a tracking bit, or tracking bits, corresponding to that address may be set to indicate that the memory region includes a remapped memory location. The memory module controller (FIG. 1,101) may check the tracking bit(s) to determine whether a remapped memory operation should be performed.

FIG. 6 is a diagram of a multi-dimensional data structure according to one example of the principles described herein. In a multi-dimensional data structure a number of address bits (611) may be divided into groups. For example, 10 address bits may be split into a first group of 5 address bits (611-1) and a second group of 5 address bits (611-2). Each group of bits may identify a number of memory regions (606). For example, the first group of 5 address bits (611-1) may uniquely identify approximately 32 memory regions (606-1) and the second group of 5 address bits (611-2) may uniquely identify approximately 32 different memory regions (606-2). By crossing the memory regions (606) as indicated by the dashed lines in FIG. 6, 1,024 memory sub-regions (612) may be uniquely identified. As indicated in FIG. 6, the intersection of each dashed line may indicate a particular memory sub-region (612). Using a multi-dimensional data structure may be beneficial in that fewer tracking bits are used for the same number of address bits (611). In this example, 64 tracking bits, 32 in each direction, may be used to identify the 1,024 uniquely identified sub-regions (612) as compared to the 1,024 tracking bits used in a flat data structure. In some examples the tracking bits may be set to indicate whether corresponding address bits (611) indicate a memory sub-region (612) includes a remapped memory location. The memory module controller (FIG. 1, 101) may check the tracking bit(s) to determine whether a remapped mapping operation should be performed, or a write operation.

A process for identifying a memory sub-region (612) that contains a remapped memory location is given as follows. In this example, one of the 32 regions in each group is set based on the 5 address bits used for that group. For example, the first group of address bits (611-1) may indicate a first memory region (606-1) of that group includes a remapped location, as indicated by the “X.” Similarly, the second group of address bits (611-2) may identify a second memory region (606-2) that includes a remapped location, as indicated by the “X.” The intersection of the dashed lines corresponding to the “X”'s may indicate a memory sub-region (612) that includes a remapped location as indicated in FIG. 6 by the circle. A similar example for a second memory sub-region (612) that contains an active remapping function is indicated by the “+” and the square. In some examples, a memory sub-region (612) may be identified by hashing address bits (611) together.

Using the multi-dimensional array as indicated in FIG. 6, a single sub-region (612) may be identified based on the memory regions (606) identified by the two groups of address bits (611). In some examples, the multi-dimensional array may lead to a false match identification. Notwithstanding this possibility, using a multi-dimensional array may still be beneficial in that the number of tracking bits to track the memory regions is much less than would otherwise be possible. In other words, a multi-dimensional array as described in FIG. 6, may achieve a greater yield of memory usage.

FIG. 7 is a diagram of a bloom filter tracking structure according to one example of the principles described herein. As described above, a set of address bits (711) may be divided into multiple groups. For example, the address groups may be split into a group of first address bits (711-1) and a second group of address bits (711-2). During tracking each group of address bits (711-1) may identify memory sub-regions (712) that include remapped memory locations. For example, the first group of address bits (711-1) may be decoded to indicate a memory sub-region (712) decoded from that set of address bits (711-1) contains a remapped memory location. Similarly, the second group of address bits (711-2) may be decoded to indicate a memory sub-region (712) from that set of address bits (711-2) contains a remapped memory location. As depicted in FIG. 7, the memory sub-region (712) defined by the bits indicated by the “X” may be a first active sub-region (712). A second active sub-region (712) may be identified in a similar fashion as indicated by the “+” indication. In some examples, when the address bits (711) indicate a memory sub-region (712) contains a remapped memory location, the corresponding tracking bit may be set to so indicate to the memory module controller (FIG. 1, 101).

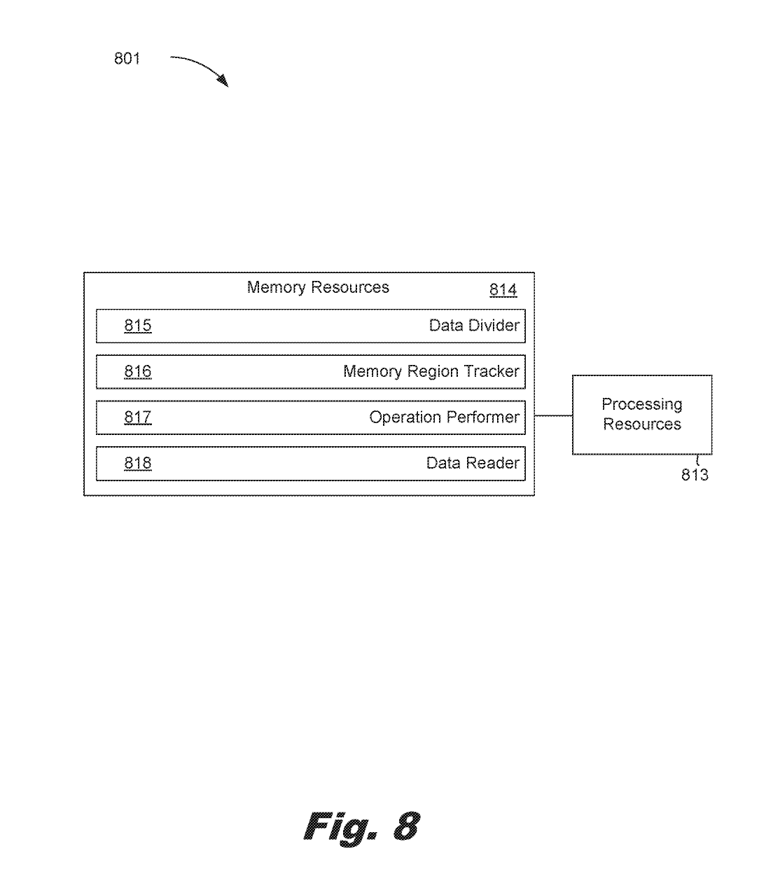

FIG. 8 is a diagram of a memory module controller (801) for identifying memory regions (FIG. 1, 106) that contain remapped memory locations according to one example of the principles described herein. The memory module controller (801) may include the hardware architecture to retrieve executable code and execute the executable code. The executable code may, when executed by the memory module controller (801), cause the memory module controller (801) to implement at least the functionality of identifying memory regions (FIG. 1, 106) that contain remapped memory locations, according to the methods of the present specification described herein. In the course of executing code, the memory module controller (801) may receive input from and provide output to a number of the remaining hardware units.

In this example, the memory module controller (801) may include processing resources (813) that are in communication with memory resources (814). Processing resources (813) may include at least one processor and other resources used to process programmed instructions. The memory resources (814) represent generally any memory capable of storing data such as programmed instructions or data structures used by the memory module controller (801). The programmed instructions shown stored in the memory resources (814) may include a data divider (815), a memory region tracker (816), an operation performer (817), and a data reader (818).

The memory resources (814) include a computer readable storage medium that contains computer readable program code to cause tasks to be executed by the processing resources (813). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The data divider (815) represents programmed instructions that, when executed, cause the processing resources (813) to divide the memory within a computing device into a number of memory regions. The data divider (815) may be implemented by the divide module (FIG. 1, 102). The memory region tracker (816) represents programmed instructions that, when executed, cause the processing resources (813) to determine from a number of tracking bits on a memory module controller, whether a memory region includes a remapped memory location. The memory region tracker (816) may be implemented by the track module (FIG. 1, 103). The operation performer (817) represents programmed instructions that, when executed, cause the processing resources (813) to perform a remapped memory operation on the memory region based on a determination as to whether a memory region includes a remapped memory location. The operation performer (817) may be implemented by the operation module (FIG. 1, 104). The data reader (818) represents programmed instructions that, when executed, cause the processing resources (813) to perform a read operation when the memory region includes a remapped memory location.

Further, the memory resources (814) may be part of an installation package. In response to installing the installation package, the programmed instructions of the memory resources (814) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (813) and the memory resources (814) are located within the same physical component, such as a server, or a network component. The memory resources (814) may be part of the physical components main memory, caches, registers, non-volatile memory, or elsewhere in the physical components memory hierarchy. Alternatively, the memory resources (814) may be in communication with the processing resources (813) over a network. Further, the data structures, such as the libraries, may be accessed from a remote location over a network connection while the programmed instructions are located locally. Thus, the memory module controller (802) may be implemented on a user device, on a server, on a collection of servers, or combinations thereof.

The memory module controller (802) of FIG. 8 may be part of a general purpose computer. However, in alterative examples, the memory module controller (802) is part of an application specific integrated circuit.

Methods and systems for establishing atomic and durable memory using a versioned memory design may have a number of advantages, including: (1) improving granularity of remapping procedures; (2) efficiently using memory space; and (3) reduce memory access latency.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor resources (813) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for identifying memory regions that contain remapped memory locations, comprising:
determining, from a number of tracking bits on a memory module controller, whether a memory region comprises a remapped memory location; and
performing a remapped memory operation on the memory region based on the determination, wherein memory within a computing device is divided into a number of memory regions including the memory region.

2. The method of claim 1, in which the remapped memory location was remapped using a fine grained remapping with error checking and correcting and embedded pointers (FREE-p) mapping operation.

3. The method of claim 1, in which determining whether a memory region comprises a remapped memory location comprises determining a value of a number of tracking bits that correspond to the memory region.

4. The method of claim 1, in which a remapped memory location comprises a number of failed memory bits.

5. The method of claim 1, further comprising performing a write operation when the memory region does not comprise a remapped memory location.

6. The method of claim 1, in which performing a remapped memory operation comprises performing a read operation and performing a write operation when the memory region comprises a remapped memory location.

7. A system for identifying memory regions that contain remapped memory locations, comprising:
a processor;
memory communicatively coupled to the processor; and
a memory module controller, the memory module controller comprising:
a divide module to divide memory into a number of memory regions, a memory region comprising a number of memory locations;
a track module to identify memory regions that comprise a remapped memory location based on a number of tracking bits located in the memory module controller, and
an operation module to perform a remapped write operation to a memory region identified as containing the remapped memory location.

8. The system of claim 7, in which the remapped memory location was remapped using a fine grained remapping with error checking and correcting and embedded pointers (FREE-p) mapping function.

9. The system of claim 7, further comprising a read module to read data from the remapped memory location.

10. The system of claim 7, in which the divide module divides the memory into a multi-dimensional data array structure.

11. The system of claim 7, in which the track module uses a bloom filter to identify memory regions that comprise the remapped memory location.

12. The system of claim 7, in which the divide module divides memory based on a hashing function.

13. The system of claim 7, in which the track module is located within volatile memory of a computing device.

14. A computer program product for identifying memory regions that contain remapped memory locations, the computer program product comprising:
a computer readable storage medium comprising computer usable program code embodied therewith, the computer usable program code comprising:
computer usable program code to, when executed by a processor, divide memory within a computing device into a number of memory regions;
computer usable program code to, when executed by a processor, identify a number of remapped memory locations within a memory region based on a number of tracking bits within a memory module controller; and
computer usable program code to, when executed by a processor, perform a remapped memory operation to the number of remapped memory locations, in which the remapped memory operation is based on a remapping function.

15. The computer program product of claim 14, in which the remapping function is a fine grained remapping with error checking and correcting and embedded pointers (FREE-p) mapping function.
